(19) United States
(12) Patent Application Publication
(10) Pub. No.: US 2013/0068386 A1
(43) Pub. Date: Mar. 21, 2013

(54) FILM-FORMING RADIATION-CROSSLINKING ADHESIVE

(71) Applicant: Henkel AG & Co. KGaA, Duesseldorf (DE)

(72) Inventors: Melanie Lack, Duesseldorf (DE); Thomas Moeller, Duesseldorf (DE); Andrea Krlejova, Duesseldorf (DE)

(73) Assignee: Henkel AG & Co. KGaA, Duesseldorf (DE)

(21) Appl. No.: 13/673,631

(22) Filed: Nov. 9, 2012

Related U.S. Application Data
(63) Continuation of application No. PCT/EP2011/055594, filed on Apr. 11, 2011.

(30) Foreign Application Priority Data
May 11, 2010 (DE) 102010028870.5

(51) Int. Cl. C09J 175/04; B32B 37/06; C09J 7/02; B32B 7/12; B32B 5/02

(52) U.S. Cl. CPC C09J 175/04; B32B 7/12; B32B 5/022; C09J 7/0242; B32B 37/06
USPC 156/275.5; 522/174; 522/68; 442/381; 428/349

(57) ABSTRACT

Radiation-crosslinkable hot-melt adhesives containing more than 50% of polyurethane polymers which contain at least one radiation-polymerizable reactive group. The radiation-crosslinkable hot-melt adhesive is prepared by reacting a) a reactive PU prepolymer having a particular block structure b) 20 to 95 mol % of at least one low-molecular-weight compound (B) containing a radically polymerizable double bond and a group reacting with an NCO group; c) 0 to 50 mol % of at least one compound (C) having at least one group reactive to NCO groups but no group that is polymerizable under radical conditions, with a molar mass of 32 to 5000 g/mol; d) 5 to 50 mol % of at least one radical photoinitiator (D) having a primary or secondary OH group, as well as optionally further polymers and/or auxiliary substances. The adhesives can be cured for bonding nonwoven substrates or for coating labels, tapes, films and plasters with pressure-sensitive adhesive coatings.

The invention relates to radiation-crosslinkable hot-melt adhesives based on reactive polyurethanes which have a high modulus (G′) after crosslinking. They should allow a good bonding of nonwoven substrates.

Radiation-curing adhesives are generally known. Free-flowing, frequently low-viscosity adhesives for example are crosslinked here by radical or cationic polymerization to produce pressure-sensitive adhesives or permanently bonded layers. The polymers must be matched to the substrate surfaces in order to ensure good adhesion.

Radiation-crosslinkable adhesives for bonding plastic films to various substrates are one particular area of application. In many sanitary products, for example, films are bonded to films or films bonded to nonwoven fabric. In order to achieve an elastic bond between the various materials, as is necessary in this field, elastic adhesives are selected. The necessary strength of the composite is provided by the substrate.

Radiation-curing hot-melt adhesives are known for example from DE 4041753 Al or WO 02/34858. Urethane-based coating compositions that are polymerizable in two stages are described here which are strengthened by a content of UV-polymerizable acrylate groups in a first curing stage and which then undergo an irreversible crosslinking via isocyanate groups in a subsequent second stage. Monofunctional acrylates are added to the adhesive as reactive thinners to lower the viscosity. However, adhesives containing isocyanates can be toxic.

EP 1262502 describes a linear polymer having a polyester backbone comprising an unsaturated double bond at one chain end and alcohol reacted at the other end. No adhesives bearing initiator groups reacted at the base polymer are described there. Tear-resistant two-dimensional supporting layers are described there as the substrate.

DE 102007015801 describes adhesives that can be used as an adhesive for gluing labels. Radiation-crosslinkable prepolymers produced on the basis of polyether- or polyester-polyurethane prepolymers are also described. Only high-molecular weight diols are used; a PU prepolymer as a block copolymer with a block consisting of low-molecular-weight alkylene diols and diisocyanates is not described. These adhesives are applied to supporting films, for example.

UV-crosslinking adhesives are also known from WO 2005/105857. This describes reaction products comprising a polyester diol, a polyether thiol together with an OH-functional acrylate, which are reacted with polyisocyanates. These prepolymers are then mixed with monomeric acrylates and initiators and used as a reactive adhesive.

The known adhesives have the disadvantage that low-molecular-weight decomposition substances form during crosslinking due to the necessary initiator. This can be undesirable in many areas of application, for example if the bondings can come into contact with the skin, as skin-irritating or skin-damaging reactions are possible. Moreover the crosslinked adhesive layers are unstable: in tensile tests of these composites a cohesive failure in the adhesive is observed. The mechanically stable part of a composite is the supporting film.

The object of the present invention is therefore to provide a suitable adhesive for bonding nonwoven fabrics, wherein the adhesive contains no free initiators and the adhesive film exhibits a high modulus after crosslinking. It can also be made mechanically stable and produces a tear-resistant polymer film. Furthermore, a method for bonding nonwoven components should be provided. This method should also allow nonwovens to be bonded directly, without including a supporting film between the nonwoven components.

The object is achieved by providing a radiation-crosslinking hot-melt adhesive according to the claims. A hot-melt adhesive is provided here that contains a polyurethane polymer containing at least one radiation-crosslinkable group and at least one group of a radical photoinitiator, the polyurethane polymer being produced from a reactive polyurethane prepolymer having at least two NCO groups. The polyurethane prepolymer should furthermore have a block structure produced from a high-molecular-weight polyether polyol reacted in the terminal position with diisocyanates, wherein reacted at one end or at all ends this reaction product contains a block consisting of 4 to 50 alkylene diol units reacted with diisocyanates, said alkylene diol unit having a molecular weight of less than 300 g/mol. This NCO-terminated prepolymer having block structures should be reacted at some of the NCO groups with low-molecular-weight bifunctional compounds containing radically crosslinkable double bonds and a group that reacts with NCO groups; additionally reacted with at least one radical photoinitiator which contains an OH group and is then present at some of the NCO groups in a reacted state; optionally reacted with monofunctional compounds having no further radically crosslinkable groups. The amount of reacted compounds should correspond to the amount of NCO groups in the prepolymer. The PU polymer that is formed should substantially contain no more free NCO groups. The adhesive can contain further polymers and/or auxiliary substances.

The invention also provides the use of such hot-melt adhesives having radiation-crosslinkable functional groups for bonding nonwoven substrates. The invention also provides the use of such hot-melt adhesives for producing bonded, tear-resistant multilayer objects constructed from at least one nonwoven fabric and an adhesive film.

The hot-melt adhesive according to the invention consists substantially of a PU polymer having terminally crosslinkable reactive double bonds. There must also be chemically bonded initiators at the PU polymer. The PU polymer can additionally have free, non-crosslinkable polymer chain ends. The PU polymer should be produced from an NCO-reactive polyurethane prepolymer and have a block structure.

The polyurethane prepolymer A) as the basis for the further reactions should have a block structure. This can be produced by the stepwise reaction of long-chain diols and/or triols with an excess of diisocyanate compounds, preferably with asymmetrical diisocyanates, wherein this intermediate is then reacted in a further reaction with diisocyanates and low-molecular-weight diols. The proportions are chosen such that terminally NCO-functionalized prepolymers are obtained. A use of portions of trifunctional polyols or isocyanates is possible. In particular, however, the prepolymers should be linear, i.e. be produced from diols and diisocyanates. The polyols and polyisocyanates that can be used in the synthesis of the PU prepolymers are known to the person skilled in the art.

The aromatic or aliphatic diisocyanates that are known for adhesives use can be used. The preferably suitable asymmetrical diisocyanates are monomeric aromatic, aliphatic or cycloaliphatic di- or triisocyanates having at least two isocyanate groups of differing reactivity. Examples are 2,4′-diphenylmethane diisocyanate (MDI), hydrogenated 2,4′-MDI (H12MDI), 2,4-toluylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1, 5,5-trimethylcyclohexane (IPDI) or lysine diisocyanate. Aliphatic asymmetrical diisocyanates are particularly suitable.

Polyisocyanates that are produced by trimerization or oligomerization of diisocyanates or by reacting diisocyanates in excess with polyfunctional or trifunctional compounds containing hydroxyl or amino groups are suitable as trifunctional isocyanates that can optionally be used in part. The asymmetrical diisocyanates already mentioned above are suitable isocyanates for producing trimers. The trimerization products of aliphatic isocyanates are preferred, in particular those based on TMXDI or IPDI.

The proportion of aromatic isocyanates should preferably be less than 50% of the isocyanates. PU prepolymers based on aliphatic or cycloaliphatic polyisocyanates, in particular based on IPDI and/or hydrogenated 2,4′-MDI, are particularly preferred.

The known polyols having a molecular weight from over 1000 to 50,000 g/mol can be selected as long-chain difunctional or trifunctional polyols. It is convenient for these polyols to have a glass transition temperature of less than 20° C., preferably less than 0° C., particularly preferably less than −20° C. Preferred polyols are moreover liquid at room temperature. Any melting points should be below 30° C., preferably below 20° C., particularly preferably below −20° C. Examples of such polyols are polyethers, polyesters, polyester amides, poly(meth)acrylates or polyolefins containing OH groups. Poly(meth)acrylates that are suitable in particular are produced by controlled radical polymerization. Such known methods include for example reversible addition fragmentation (RAFT), nitroxide-mediated radical polymerization (NMP), atom transfer radical polymerization (ATRP) or single-electron transfer-living radical polymerization (SET-LRP). Poly(meth)acrylates having terminal OH groups are particularly preferred.

Further examples of suitable polyols for producing the PU prepolymer are polyester polyols consisting of dicarboxylic acids and polyether diols, in particular as polyether-polyester block copolymers. The known polyesters having a molecular weight of less than 6000 g/mol, in particular less than 2500 g/mol, can be used as the polyester component. The polyether polyols known to the person skilled in the art and having a molecular weight of less than 5000 g/mol can be selected as the polyether diol. It is however necessary for the polyether component of the polyether-polyester polyols to encompass at least 65 wt. % of the polymer chain.

Polyether polyols are likewise suitable. Polyether polyols are preferably obtained by reacting low-molecular-weight polyols with alkylene oxides. The alkylene oxides preferably have two to four C atoms. The reaction products of ethylene glycol, propylene glycol or the isomeric butane diols with ethylene oxide, propylene oxide or butylene oxide are suitable, for example. Reaction products of polyfunctional alcohols such as glycerol, trimethylolethane or trimethylolpropane, pentaerythritol or sugar alcohols with the cited alkylene oxides to give polyether polyols are also suitable. They can be homopolymers, random polymers or block copolymers.

Polyols having terminal OH groups are suitable in general. A particularly preferred embodiment uses polyether polyols having a molecular weight from approximately 1500 to approximately 50,000 g/mol, preferably from approximately 3000 to approximately 30,000 g/mol. Polyethers having at least 50% polyethylene glycol units, in particular linear polyether diols, are suitable in particular.

In a first process stage an NCO-terminated PU prepolymer can be produced from the polyol and an excess of the diisocyanates. This has a block of the structure
diisocyanate-polyether polyol-diisocyanate.
   At this intermediate at least one other block of low-molecular-weight diols/diisocyanates of the structure
-(diol-diisocyanate)ₙ,
   where n is equal to 4 to 50 and the diols are selected from alkylene diols having a molecular weight of less than 300 g/mol, is then reacted to the isocyanate groups. The intermediate can be reacted by reaction with the aforementioned diisocyanates and the low-molecular-weight diols. In a particular embodiment aliphatic diisocyanates, preferably asymmetrical diisocyanates, are used to produce the NCO prepolymers.

Low-molecular-weight alkylene diols are understood to be aliphatic, cycloaliphatic or aromatic diols having a molecular weight from 62 g/mol to 300 g/mol. Examples are ethylene glycol, diethylene glycol, propylene glycol, neopentyl glycol, butanediol-1,4, pentanediol-1,5, hexanediol-1,6, heptanediol-1,7, octanediol-1,8, decanediol-1,10, 1,4-hydroxymethylcyclohexane, 2-methyl-1,3-propanediol, catechol, resorcinol, hydroquinone, 2,4-hydroxytoluene. Aliphatic diols having a molecular weight below 200 g/mol are preferred in particular.

The amount of diols is selected such that between 4 and 50 diol units are reacted at the reactive ends of the first stage, in particular up to 20. In particular, one block can be reacted at both ends of the intermediate. The amount of diisocyanates is selected correspondingly in excess so that an NCO-containing prepolymer is obtained.

The NCO terminated prepolymers can be produced with a block structure. These are however random prepolymers, which means that portions of prepolymers having similar structures can also form and be present in the mixture.

The reaction of the polyols with the polyisocyanates can take place for example in the presence of solvents; a solvent-free method is preferably used, however. To accelerate the reaction the temperature is conventionally raised, for example to between 40 and 80° C. Catalysts conventionally used in polyurethane chemistry can optionally be added to the reaction mixture to accelerate the reaction. Examples are the addition of dibutyl tin dilaurate, dimethyl tin didecanoate, dimethyl tin dineodecanoate or diazabicyclooctane (DABCO). The amount should be from approximately 0.001 wt. % to approximately 0.1 wt. % of the prepolymer. The reactive PU prepolymers A that are formed bear three or preferably two isocyanate groups. They are terminal NCO groups.

In a further reaction some of the NCO groups are reacted with bifunctional compounds B) bearing a functional group that is capable of reacting with isocyanates and having as a further functional group a double bond that can be crosslinked by radical polymerization. These conventionally have a molecular weight of less than 1500 g/mol.

Examples of such compounds are esters of α-β-unsaturated carboxylic acids with low-molecular-weight, in particular aliphatic, alcohols bearing a further OH group in the alkyl residue. Examples of such carboxylic acids are acrylic acids, methacrylic acid, crotonic acids, itaconic acid, fumaric acid and maleic acid semiesters. Corresponding esters of (meth)acrylic acid bearing OH groups are for example 2-hydroxyethyl(meth)acrylamide, 2-hydroxyethyl(meth)acrylate, 2-hydroxypropyl(meth)acrylate, 3-hydroxypropyl(meth)acrylate, 3-hydroxypropyl(meth)acrylamide, N-hydroxyethyl(meth)acrylamide, reaction products of glycidyl ethers or esters with acrylic or methacrylic acid, for example reaction products of versatic acid glycidyl esters with acrylic or methacrylic acid, adducts of ethylene oxide or propylene oxide with (meth)acrylic acid, reaction products of hydroxyl acrylates with ε-caprolactone or partial transesterification products of polyalcohols, such as pentaerythritol, glycerol or trimethylolpropane, with (meth)acrylic acid.

The amount of the OH-functional compound having radically polymerizable double bonds is chosen such that 20 to 95 mol %, in particular 22 to 90 mol %, preferably 25 to 85 mol %, relative to the NCO groups of the PU prepolymer, are used. A preferred embodiment uses a mixture of methacrylates and acrylates, the proportion of acrylates making up at least 20%, in particular at least 25%, of the mixture. As the upper limit of acrylates, the mixture can contain up to 90%.

The NCO-reactive PU prepolymer can optionally be reacted with at least one compound C) which has at least one group that is reactive with isocyanates and moreover has no further group that is polymerizable under radical conditions. Examples of such groups that are reactive with isocyanates are OH, SH or NHR groups. These compounds C) should have a molecular weight of between 32 and 10,000 g/mol, in particular up to 4000 g/mol.

Suitable monofunctional compounds are for example alcohols having 1 to 36 C atoms, such as for example methanol, ethanol, propanol and higher homologs, and the corresponding thio compounds. Monohydroxy- or monoamino-functional polymers having a molecular weight of less than 10,000 g/mol, in particular of 200 and 2000 g/mol, can moreover also be used. Mixtures of low-molecular-weight and polymeric building blocks are also possible. The functional group should in particular be an OH group. The amount should be 0 to 50 mol %, in particular 2 to 35 mol %.

As a further necessary constituent of the PU prepolymer, a photoinitiator (D) is incorporated by reaction, which when irradiated with light of a wavelength from approximately 215 nm to approximately 480 nm is capable of initiating a radical polymerization of olefinically unsaturated double bonds. This must additionally contain a group that is reactive with NCO groups. In the context of the present invention all commercial photoinitiators that are compatible with the hot-melt adhesive according to the invention and that can be incorporated by reaction are suitable in principle.

These are for example all Norrish type I fragmenting and Norrish type II substances. Examples are photoinitiators of the Kayacure range (manufacturer: Nippon Kayaku), Trigonal 14 (manufacturer: Akzo), photoinitiators of the Irgacure®, Darocure® range (manufacturer: Ciba-Geigy), Speedcure® range (manufacturer: Lambson), Esacure range (manufacturer: Fratelli Lamberti) or Fi-4 (manufacturer: Eastman).

Of these initiators, those having at least one OH group that is reactive with NCO groups, for example a primary or secondary OH group, are selected according to the invention. This OH group should react with some of the NCO groups of the PU prepolymer and be bonded to the polymer. The amount of reactive initiators should be at least 2 mol %, relative to the NCO groups of the PU prepolymer, in particular between 5 and 50 mol %, preferably between 10 and 30 mol %. The selected initiator is added during synthesis of the polymer, wherein the sum of components B, C, D should add to 100 mol %, relative to the NCO groups of the PU prepolymer.

The reaction methods for reacting the reactive PU prepolymers are known to the person skilled in the art. A reaction can take place in the mixture, or the constituents can be reacted one after another. Following the reaction randomly functionalized PU block copolymers are obtained.

In another embodiment polyfunctional NCO-reactive compounds are used as component C. The amount is chosen such that the OH:NCO ratio is 2:1, with difunctional hydroxyl compounds preferably being selected. It can be convenient here to add component C as the final constituent of prepolymer production. PU polymers bearing OH groups are then formed.

Examples of such compounds are diols, triols or polyols, preferably diols or triols, in particular diols. Suitable compounds are for example polyols having 2 to 44 C atoms, for example ethylene glycol, propanediol, butanediol and higher homologs, and the corresponding thio compounds. The amounts of these polyols are chosen such that a suitable molar excess of this reactive functionality relative to the NCO groups is present. A chain extension of the NCO prepolymers can take place, but preferably only one OH group should be reacted, and free OH groups are obtained. The molecular weight of this higher-functional compound C) should be up to 10,000 g/mol, in particular from 200 to 3000 g/mol.

A PU polymer that is suitable according to the invention can for example consist of a block copolymer containing 20 to 95 mol % of functional group B, 0 to 50 mol % of group C and 5 to 50 mol % of group D, wherein the sum corresponds to 100 mol % of the NCO groups.

The PU polymer should have a molecular weight of less than 200,000 g/mol, in particular between 1000 and 100,000 g/mol, preferably between 2000 and 50,000 g/mol, in particular below 20,000 g/mol. The PU polymer should be substantially free from isocyanate groups, in other words only traces of unreacted NCO groups should still be present following the conversion reaction.

The hot-melt adhesive according to the invention must contain more than 35 wt. % of reactive PU polymers. The hot-melt adhesive can moreover contain further different polymers and auxiliary substances that are suitable for influencing the properties. These are for example further thermoplastic polymers, reactive thinners, resins, stabilizers, antioxidants, plasticizers, further photoinitiators, adhesion promoters, dyes and/or fillers.

The hot-melt adhesive can for example also contain additional proportions of reactive thinners. Compounds having one or more reactive functional groups that can be polymerized by irradiation with UV light or with electron beams are particularly suitable as reactive thinners.

Difunctional or higher-functional acrylate or methacrylate esters having three to six (meth)acrylic groups are suitable in particular. Such acrylate or methacrylate esters encompass for example esters of acrylic acid or methacrylic acid with aromatic, aliphatic or cycloaliphatic polyols or acrylate esters of polyether alcohols. The amount can be from 0 to 10 wt. %, in particular . more than 0.1 wt. %, preferably 2 to 5 wt. %. The crosslink density of the hot-melt adhesive according to the invention can be increased in this way.

Likewise suitable compounds are for example the acrylic acid or methacrylic acid esters of aromatic, cycloaliphatic, aliphatic, linear or branched C₄₋₂₀ monoalcohols or of corresponding ether alcohols. Examples of such compounds are 2-ethylhexyl acrylate, octyl/decyl acrylate, isobornyl acrylate, 3-methoxybutyl acrylate, 2-phenoxyethyl acrylate, benzyl acrylate or 2-methoxypropyl acrylate, neopentyl glycol di(meth)acrylate, 1,6-hexanediol di(meth)acrylate, trimethylolpropane tri(meth)acrylate, pentaerythritol tetra(meth)acrylate, and (meth)acrylate esters of sorbitol and other sugar alcohols. These (meth)acrylate esters of aliphatic or cycloaliphatic diols can optionally be modified with an aliphatic ester or an alkylene oxide. Acrylates modified with an aliphatic ester encompass for example neopentyl glycol hydroxypivalate di(meth)acrylate, caprolactone-modified neopentyl glycol hydroxypivalate di(meth)acrylate and the like. Alkylene oxide-modified acrylate compounds encompass for example ethylene oxide-modified neopentyl glycol di(meth)acrylates, propylene oxide-modified neopentyl glycol di(meth)acrylates, ethylene oxide-modified 1,6-hexanediol di(meth)acrylates or propylene oxide-modified 1,6-hexanediol di(meth)acrylates, neopentyl glycol-modified (meth)acrylates, trimethylolpropane di(meth)acrylates, polyethylene glycol di(meth)acrylates, polypropylene glycol di(meth)acrylates and the like. Trifunctional and higher-functional acrylate monomers encompass for example trimethylolpropane tri(meth)acrylate, pentaerythritol tri- and tetra(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, caprolactone-modified dipentaerythritol hexa(meth)acrylate, pentaerythritol tetra(meth)acrylate, tris[(meth)acryloxyethyl]isocyanurate, caprolactone-modified tris[(meth)acryloxyethyl]isocyanurates or trimethylolpropane tetra(meth)acrylate or mixtures of two or more thereof.

In one embodiment the hot-melt adhesive according to the invention contains at least one tackifying resin. The resin brings about an additional tackiness. All resins that are compatible with the hot-melt adhesive, i.e. that form a largely homogeneous mixture, can be used in principle.

In particular these are resins which have a softening point of 70 to 140° C. They are for example aromatic, aliphatic or cycloaliphatic hydrocarbon resins, and modified or hydrogenated versions thereof. Examples are aliphatic or alicyclic petroleum-hydrocarbon resins and hydrogenated derivatives thereof, hydroabietyl alcohol and esters thereof; modified natural resins such as gum rosin, tall-oil rosin or wood rosin, colophony and derivatives thereof; acrylic acid copolymers, preferably styrene-acrylic acid copolymers, and resins based on functional hydrocarbon resins.

The resins can be chemically inert or they still bear functional groups, such as double bonds, acid or OH groups. The resin can be used in an amount from 0 to 70 wt. %, preferably from 10 to 40 wt. %, relative to the hot-melt adhesive.

Medical white oils, naphthenic mineral oils, paraffinic hydrocarbon oils, phthalates, adipates, polypropylene, polybutene, polyisoprene oligomers, hydrogenated polyisoprene and/or polybutadiene oligomers, benzoate esters, vegetable or animal oils and derivatives thereof are used for example as plasticizers. Phenols, sterically hindered phenols of high molecular weight, polyfunctional phenols, sulfur-containing and phosphorus-containing phenols or amines can be selected as suitable stabilizers or antioxidants. Titanium dioxide, talc, clay and the like for example can be selected as pigments. Waxes can optionally be added to the hot-melt adhesive. The amount should be determined such that adhesion is not negatively influenced. The wax can be of natural or synthetic origin.

Furthermore, photosensitizers can additionally be used if convenient. Through the use of photosensitizers it is possible to extend the absorption of photopolymerization initiators to shorter and/or to longer wavelengths and in this way to accelerate crosslinking. The radiation of a certain wavelength that they absorb is transferred as energy to the photopolymerization initiator. Photosensitizers that can be used in the context of the invention are for example acetophenone, thioxanthanes, benzophenone and fluoroscein and derivatives thereof.

It is optionally possible, in addition to the partly reacted initiator, for up to 5 wt. % of further unbonded initiators to be contained in the hot-melt adhesive, in particular from 0 to 3 wt. %. This can be an excess of the reacted initiator, but different initiators can also be added. These can also exhibit a different absorption behavior in respect of UV radiation.

There can optionally be proportions of thermoplastic polymers in the adhesives according to the invention; these can for example be polymers with a molecular weight of greater than 1000 g/mol. These contain no reactive groups; in another embodiment these polymers can have vinylically unsaturated groups. For example, polymers from the group of polyacrylates, polymethacrylates and copolymers thereof, ethylene-n-butyl acrylate copolymers, ethylene-(meth)acrylic acid copolymers, ethylene-vinyl acetate copolymers, polyvinyl methyl ethers, polyvinyl pyrrolidone, polyethyloxazolines, polyamides, starch or cellulose esters, amorphous polyolefins, for example polypropylene homopolymers, propylene-butene copolymers, propylene-hexene copolymers and in particular amorphous poly-alpha-olefin copolymers (APAOs) are included.

These further polymeric constituents can be included in amounts from 0 to 30 wt. %, in particular 2 to 20 wt. %, in the hot-melt adhesive according to the invention. The molecular weight is generally above 1000, preferably above 10,000 g/mol. The selection and the properties of the thermoplastic polymers are known to the person skilled in the art.

A hot-melt adhesive can for example contain 35 to 80 wt. % of PU polymer, 0 to 60% of resins, 0 to 30% of further polymers and up to 20 wt. % of further additives.

Altogether the individual constituents of the adhesive should add to 100 wt. %. Selection is possible for the person skilled in the art in accordance with the required properties, for example to influence the viscosity, the adhesion to the substrates, the stability of the adhesive or the cohesion of the adhesive. Methods for producing the PU polymers that are suitable according to the invention and for producing the adhesives are known. The aforementioned hot-melt adhesives are solvent-free and are solid at room temperature.

The hot-melt adhesives according to the invention are applied and then crosslinked. The adhesive layers that form in this process are tacky. They can form an elastic film. In particular, as a free film these layers have a high modulus (G′). As a film they then exhibit good mechanical stability. The ultimate elongation as a crosslinked specimen (dumbbell) is over 500%. The extensibility of a film is elastic.

The invention also provides the use of these hot-melt adhesives for bonding nonwoven fabrics. Plastic films can be bonded to nonwoven fabric, but it is possible in particular for two nonwoven substrates to be bonded directly to one another.

Films as a substrate generally consist of thermoplastics, in particular rubbery-elastic plastics. These can be produced on the basis of styrene block copolymers, polyurethane, polyesters, polyether block copolymers or polyolefins. Films consisting of styrene block copolymers are known in particular, for example styrene-isoprene-styrene, styrene-butadiene-styrene, styrene-ethylene block copolymers, polyethylene and copolymers, polypropylene and copolymers and polyethylene-C₃ to C₁₂ α-olefin copolymers.

Suitable supporting films have the characterizing feature of a rubbery-elastic extension, i.e. following an elongation in one direction the corresponding films contract again when loading is ended. The films can have a thickness of 5 to 75 μm, in particular 10 to 50 μm.

Nonwoven fabric layers can be the second coating material, which is to be bonded to one or both sides of the film. Such nonwoven fabrics are two-dimensional, flexible entities. They are produced by interlooping textile fibers, as spunbond for example, or by intermingling them (spunlace). Such nonwovens are highly flexible and are also permeable to gases and liquids. The fibers or filaments that are processed to form nonwoven fabrics generally consist of polypropylene, polyethylene, polyester or viscose. Such nonwovens are highly flexible and can generally also be extended. Such nonwovens are known to the person skilled in the art and can be selected according to the intended application, for example according to the film thickness.

The use of hot-melt adhesives that are suitable according to the invention involves applying them in the molten state to a substrate, bonding them in the subsequent process step and then crosslinking them by radiation.

Another preferred embodiment of the invention uses such adhesives for the direct bonding of two nonwoven substrates. Here the adhesive is melted and applied to one nonwoven fabric. It is also possible to coat both substrates with the adhesive. Application can in principle take place by the known application methods, for example spray application, flat film dies or printing processes. The two substrates are then brought together and bonded by cooling the adhesive.

For problem-free processing, the hot-melt adhesives according to the invention should have a low viscosity prior to irradiation; at 130° C. this should conventionally be 200 mPas to 10,000 mPas, in particular from 300 mPas to 3000 mPas or from 5000 to 10,000 mPas. The amount of adhesive that is applied should be from 10 to 150 g/m², in particular from 15 to 100.

The hot-melt adhesives according to the invention have the required low viscosity at the processing temperatures, such as is desired for example for use on heat-sensitive nonwoven materials. The processing temperatures are in the range from 50° C. to 200° C., preferably in the range from 70° C. to 150° C. Processing takes place on machines known per se.

Following application of the hot-melt adhesive according to the invention and the bringing together of the components to be bonded, the hot-melt adhesive according to the invention is irradiated with an adequate dose of UV or electron beams so that the hot-melt adhesive crosslinks. An adequate cohesion develops in this way. The irradiation period should be less than 5 seconds. UV radiation is preferably used. In one embodiment irradiation and crosslinking can take place through the film, provided that this is permeable for UV radiation. Another embodiment crosslinks the adhesive layer through the nonwoven layer. In this case it is convenient for a nonwoven layer to have a thickness of less than 5 mm, in particular up to approximately 1 mm. In this way it is possible to ensure that an adequate dose of radiation reaches the adhesive. Conventional UV radiation sources can be used, for example having a wavelength from 215 to 480 nm.

In a preferred embodiment according to the invention for bonding two nonwoven substrates no supporting film is necessary. The amount of adhesive is selected so that a two-dimensional bond occurs. The amount is 20 to 100 g/m². This ensures that a largely continuous film of adhesive is formed after crosslinking. The crosslinked adhesive film according to the invention has high mechanical stability. It is convenient here for a crosslinked film of the adhesive material to have a tear strength of more than 25 N/25 mm. A corresponding film is thus mechanically stable and can therefore be processed further directly as a composite with the nonwoven material. Furthermore, through the choice of polymers a film is obtained that has an elastic extensibility.

The invention also provides a multilayer substrate consisting of two nonwoven layers bonded to one another by a crosslinked adhesive layer. Here the adhesive layer fulfills the purpose of bonding the two nonwoven layers to one another and additionally serves as a mechanical supporting layer in this composite.

Another embodiment of the invention comprises a multilayer substrate in which there is additionally a film between the nonwoven layers. This is then bonded on both sides to the nonwoven material using an adhesive according to the invention. The multilayer substrates have a high elasticity, which means that the substrate can be extended and then flexibly reshaped to approximately the same initial shape.

After being crosslinked, the solvent-free hot-melt adhesives according to the invention have a good adhesive strength. The network that is formed has a uniform structure and markedly improves the cohesion. A tear-resistant polymer film is formed, which can replace the known supporting materials. The adhesive layer has a reduced proportion of low-molecular-weight substances, is free from isocyanate groups and free from non-covalently bonded photoinitiators. These layers are thus also suitable for use in objects that give rise to skin contact with humans. The multilayer substrates according to the invention are elastic.

A further advantage of a mode of operation according to the invention lies in the fact that in one embodiment an additional layer in the multilayer laminate can be avoided. A simplified mode of production of composite laminates and their secondary products is thus possible.

### List of Suitable Measurement Methods:

Molecular weight as the number-average molecular weight, M_{N}, as can be determined by GPC against a polystyrene standard;
Glass transition temperature, TG, measured with DSC;
Softening point by the ring and ball method, DIN 52011;
Tear strength, ultimate elongation measured at 25° C., EN ISO 1924;
Viscosity measured with a Brookfield viscometer, spindle 27, at the specified temperature, DIN ISO 2555

### COMPARATIVE EXAMPLE 1

### Without Alkylene Diol

Apparatus: 1-liter four-neck flask with stirrer; thermocouple, N2 transfer line; height-adjustable oil bath; vacuum pump with nitrogen-filled cold trap
Formulation:

| | | |
|---|---|---|
| 1.) PPG 4000 | 300.0 g | (polypropylene glycol 4000; OH value |
| | | approx. 28) |
| 2.) IPDI | 25.0 g | (isophorone diisocyanate) |
| 3.) DBTL | 0.01 g | (dibutyl tin dilaurate) |
| 4.) HEA | 5.9 g | (2-hydroxyethyl acrylate, 70 mol %) |
| 5.) Irgacure 2959 | 4.9 g | (photoinitiator, 30 mol %) |
| 6.) Irganox 1135 | 3.3 g | (antioxidant) |
| 7.) Irganox 245 | 3.4 g | (stabilizer) |

Method:

1, 6, 7 are prepared and heated to approx. 100° C. Then a vacuum is applied and the mixture is dehydrated at <10 mbar for 1 h and then aerated with nitrogen. Then 2 is added and homogenized. 3 is added as a catalyst. Stirring is continued and after 25 min the NCO value is determined at 0.57%.

The batch is aerated, 5 and then 6 are added while stirring and homogenized. After a further 1.5 hours with exclusion of light the NCO value is approximately 0. The batch is degased under vacuum and decanted. Viscosity 940 mPas (125° C.).

### COMPARATIVE EXAMPLE 2

### Random Structure

Apparatus as in Example 1
Formulation:

| | | |
|---|---|---|
| 1.) PPG 4000 | 300.5 g | (polypropylene glycol 4000; OH value |
| | | approx. 28) |
| 2.) IPDI | 62.0 g | (isophorone diisocyanate) |
| 3.) Butanediol | 10.0 g | (aliphatic diol) |
| 4.) DBTL | 0.01 g | (dibutyl tin dilaurate) |
| 5.) HEA | 16.1 g | (2-hydroxyethyl acrylate, 70 mol %) |
| 6.) Irgacure 2959 | 13.3 g | (photoinitiator, 30 mol %) |
| 7.) Irganox 1135 | 3.7 g | (antioxidant) |
| 8.) Irganox 245 | 3.8 g | (stabilizer) |

Method:

1, 3, 7, 8 are prepared and heated to approx. 100° C. Then a vacuum is applied and the mixture is dehydrated at <10 mbar for 1 h and then aerated with nitrogen. Then 2 is added and homogenized. 4 is added as a catalyst. Stirring is continued and after 25 min the NCO value is determined at 2.18%.

The batch is aerated, 6 and then 7 are added while stirring and homogenized. After a further 1.1 hours with exclusion of light the NCO value is approximately 0.1. The batch is degased under vacuum and decanted. Viscosity 470 mPas (125° C.).

### EXAMPLE 3

### Block Structure According to the Invention

Apparatus as in Example 1
Formulation:

| | | |
|---|---|---|
| 1.) PPG 4000 | 300.0 g | (polypropylene glycol 4000; OH value |
| | | approx. 28) |
| 2.) IPDI | 49.7 g | (isophorone diisocyanate) |
| 3.) DBTL | 0.01 g | (dibutyl tin dilaurate) |
| 4.) Butanediol | 10.0 g | (diol) |
| 5.) HEA | 5.6 g | (2-hydroxyethyl acrylate, 70 mol %) |
| 6.) Irgacure 2959 | 4.9 g | (photoinitiator, 30 mol %) |
| 7.) Irganox 1135 | 3.3 g | (antioxidant) |
| 8.) Irganox 245 | 3.3 g | (stabilizer) |

Method:

1, 7, 8 are prepared and heated to approx. 100° C. Then a vacuum is applied and the mixture is dehydrated at <10 mbar for 1 h and then aerated with nitrogen. Then 2 (50%) is added and homogenized. 3 is added as a catalyst. Stirring is continued and after 25 min the NCO value is determined at 0.93%.

The batch is aerated, 2 (50%) is added, the mixture stirred and then 4 added and homogenized.

After 12 min the mixture is degased, aerated with nitrogen and 5 and then 6 are added while stirring. After a further 2 hours with exclusion of light the NCO value is approximately 0. The batch is degased under vacuum and decanted. Viscosity 7200 mPas (125° C.).
Test result:

| | | |
|---|---|---|
| C1 | C2 | C3 |

100 μm, applied by knife, UV crosslinking

| | | | |
|---|---|---|---|
| E 50 [N] | 0.3 | 0.5 | 0.6 |
| E 100 [N] | 0.5 | 1.5 | 0.9 |
| Ultimate elongation [%] | <200 | <200 | 200%/1.4 N |

Cast specimen (dumbbell), UV crosslinking (EN ISO 1924)

| | | | |
|---|---|---|---|
| Ultimate elongation [%] | 160 | 320 | 920 |
| Force/cross-section | 160 | 320 | 375 |
| [N/cm²] | | | |

The adhesive layers according to the invention have an excellent ultimate elongation. Adhesives having a random structure or without diols are not tear-resistant and extensible.

### EXAMPLE 4

### According to the Invention

A PU polymer is produced as in Example 3.

22 parts of a colophony resin are added to 88 parts of the polymer and mixed in a warm atmosphere.

The adhesive is melted and applied to a nonwoven substrate (2 mm) in an amount of 75 g/m². Immediately afterwards the substrate is crosslinked with UV radiation and then bonded to a PE film (50 μm). A stable composite is formed.

### EXAMPLE 5

### According to the Invention

A PU polymer is produced as in Example 3.

15 parts of a polyolefin are added to 85 parts of the polymer and homogeneously mixed in a warm atmosphere.

The adhesive is melted and applied to a nonwoven substrate (2 mm) in an amount of 50 g/m². Immediately afterwards the substrate is crosslinked with UV radiation and then bonded to a PE film (50 μm). A stable composite is formed.

### EXAMPLE 6

### According to the Invention

A PU polymer is produced as in Example 3.

10.5 parts of a reactive thinner having unsaturated acrylate groups and 0.5 parts of a photoinitiator are added to 80 parts of the polymer and mixed together.

The adhesive is melted and applied to a nonwoven substrate (2 mm) in an amount of 100 g/m². Immediately afterwards the substrate is crosslinked with UV radiation and then bonded to a further nonwoven fabric. A stable composite is formed.

1. Radiation-crosslinkable hot-melt adhesives containing more than 35%, relative to the hot-melt adhesive, of polyurethane polymers which contain at least one radiation-polymerizable reactive group.

2. The hot melt adhesive according to claim 1, prepared by reacting
A) a reactive PU prepolymer comprising a block structure with two or three NCO groups per molecule, there being included therein one block of the structure
diisocyanate-polyol-diisocyanate
and at least one block of the structure
(diol-diisocyanate)ₙ,
where
polyol=diol or triol having a molecular weight (M_{N}) of greater than 1000 g/mol,
diol=alkylene diol having a molecular weight of less than 300 g/mol and n=4 to 50, with
B) 20 to 95 mol % of at least one low-molecular-weight compound (B) containing a radically polymerizable double bond and a group reacting with an NCO group, and
C) 0 to 50 mol % of at least one compound (C) having at least one group reactive to NCO groups but no group that is polymerizable under radical conditions, with a molar mass of 32 to 4000 g/mol, and
D) 5 to 50 mol % of at least one radical photoinitiator (D) having a primary or secondary OH group,
the % figures being related to the NCO groups of the PU prepolymer and the sum of B, C and D adding to 100 mol %,
as well as optionally further polymers and/or auxiliary substances.

3. The hot-melt adhesive according to claim 2, wherein the polyols are polyether polyols having a molar mass of 1500 to 50,000 g/mol.

4. The hot-melt adhesive according to claim 2, wherein aliphatic diisocyanates are used as the diisocyanate.

5. The hot-melt adhesive according to claim 4, wherein asymmetrical diisocyanates are used.

6. The hot-melt adhesive according to claim 2, wherein OH-functional esters of (meth)acrylic acid are used as the low-molecular-weight compound B) and/or radical photoinitiators (D) are used which have a primary OH group.

7. The hot-melt adhesive according to claim 2, wherein 2 to 35 mol % of mono- or difunctional alcohols are used as compound (C).

8. The hot-melt adhesive according to claim 2, wherein the diols have a molecular weight of 62 to 200 g/mol.

9. The hot-melt adhesive according to claim 2, wherein n is between 5 and 20.

10. The hot-melt adhesive according to claim 2, wherein further thermoplastic polymers are included, selected from those based on polyesters, polyethers, polyamides or polyolefins, optionally also containing vinyl groups, and/or auxiliary substances selected from resins, stabilizers, plasticizers and additional photoinitiators are included.

11. The hot-melt adhesive according to claim 10, wherein no free photoinitiators are included.

12. Bonded elastic films comprising cured reaction products of the hot melt adhesive according to claim 1.

13. Nonwoven substrates comprising films or nonwoven substrates bonded to one another by the cured reaction products of the hot melt adhesive according to claim 1.

14. An article comprising a substrate coated with a pressure sensitive adhesive prepared from cured reaction products of the hot melt adhesive according to claim 1.

15. Use of radiation-crosslinkable hot-melt adhesives according to claim 1 for coating labels, tapes, films, bandages and plasters with pressure-sensitive adhesive layers.

16. A method for bonding nonwoven substrates wherein one substrate is coated with an adhesive according to claim 1, the second substrate is bonded to it, then the adhesive layer is crosslinked by irradiation with actinic radiation, the irradiation taking place through one substrate layer.

17. The method according to claim 16, wherein UV radiation is used.
